(19) United States
(12) Patent Application Publication
(10) Pub. No.: US 2026/0125934 A1
(43) Pub. Date: May 7, 2026

(54) CHILD SAFETY DOOR LOCK SYSTEM

(71) Applicant: John Cryer, Minneola, FL (US)

(72) Inventor: John Cryer, Minneola, FL (US)

(21) Appl. No.: 19/368,687

(22) Filed: Oct. 24, 2025

Related U.S. Application Data
(60) Provisional application No. 63/716,399, filed on Nov. 5, 2024.

(51) Int. Cl. E05B 65/00; E05B 47/00; E05C 1/10

(52) U.S. Cl. CPC E05B 65/0014; E05C 1/10; E05B 47/0038

(57) ABSTRACT

A child safety door lock system includes a door latch device having a main body with a first cavity, a second cavity and a recessed middle section. The middle section is dimensioned for positioning the main body onto the edge of a door. A latch assembly is positioned along the main body and includes two posts that are positioned within the first and second cavities, and a hook that extends outward from the second cavity. A door catch having an opening along the front wall is secured onto the frame of the door. The door catch and door latch are horizontally aligned such that closing the door will position the hook within the opening of the catch to lock the door. The hook is removed from the catch and the door is unlocked by lifting either of the posts.

### CROSS-REFERENCE TO RELATED APPLICATIONS

This application claims the benefit of U.S. application Ser. No. 63/716,399 filed on Nov. 5, 2024, the contents of which are incorporated herein by reference.

### Technical Field

The following disclosure contemplates various embodiments of a child safety door locking system that automatically engages when a door is closed to securely lock the door to prevent the same from being opened by a child.

### BACKGROUND

The statements in this section merely provide background information related to the present disclosure and may not constitute prior art.

When young children are present in a home or office location, it can sometimes be necessary to restrict rooms in which they are able to enter/exit. For this reason, there are many known types of child safety mechanisms which can be secured onto a door. The goal of these products is to prevent the child from opening the door while allowing access by a parent or caregiver.

Although useful, these devices must be mounted onto the door itself by screws or other such hardware which damages the door and leaves unsightly holes when it is ultimately removed. Additionally, these devices are typically constructed as passive mechanisms that only work when manually locked by the adult. As such, the adult must remember to engage the child safety device each time they enter or exit the room. Unfortunately, it is not uncommon for the adult to forget to engage the safety lock, thus allowing the child to wander from the room, sometimes with horrible consequences.

The present invention, directed to a child safety door lock system differs from the conventional art in a number of aspects. The manner by which will become more apparent in the description which follows, particularly when read in conjunction with the accompanying drawings.

### SUMMARY OF THE INVENTION

The present invention is directed to a child safety door lock system. One embodiment of the present invention can include a door latch device that is connected to a door, and a door catch device that is connected to the door frame.

The door latch device can include a main body having a first cavity, a second cavity and a recessed middle section. The middle section can include dimensions suitable for positioning the main body onto the edge of an inswing or outswing door. A latch assembly can be positioned along the main body and can include a pair of posts that are positioned within the first and second cavities, and a hook having a curved surface that extends outward from the second cavity.

The door catch can include a generally rectangular-shaped member having an elongated sidewall for securement onto the jamb of a door frame, and an opening along the front wall. The door catch and door latch device can be horizontally aligned such that closing the door will cause the hook to be positioned within the opening of the door catch, thus securing the door in the locked position. The system can be unlocked by moving either of the posts to lift the hook and remove the same from the catch.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a child safety door lock system that is useful for understanding the inventive concepts disclosed herein.

FIG. 2A is a perspective view of the main body of the door latch device of the child safety door lock system, in accordance with one embodiment of the invention.

FIG. 2B is another perspective view of the main body of the door latch device of the child safety door lock system, in accordance with one embodiment of the invention.

FIG. 3A is a perspective view of the door latch device of the child safety door lock system, in accordance with one embodiment of the invention.

FIG. 3B is another perspective view of the door latch device of the child safety door lock system, in accordance with one embodiment of the invention.

FIG. 4A is a perspective view of the retaining key and door latch device of the child safety door lock system, in accordance with one embodiment of the invention.

FIG. 4B is a perspective view of the retaining key in operation with the door latch device of the child safety door lock system, in accordance with one embodiment of the invention.

FIG. 5 is a perspective view of the catch device of the child safety door lock system, in accordance with one embodiment of the invention.

FIG. 6 is a perspective view of the child safety door lock system in operation, in accordance with one embodiment of the invention.

FIG. 7 is another perspective view of the child safety door lock system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Any element in a claim that does not explicitly state “means” for performing a specified function or “step” for performing a specified function should not be interpreted as a “means” or “step” clause as specified in 35 U.S.C. 112.

### Definitions

As described herein, a “unit” means a series of identified physical components which are linked together and/or function together to perform a specified function.

As described throughout this document, the terms “about”, “approximately”, “substantially”, and “generally” shall be used interchangeably to describe a feature, shape, or measurement of a component within a tolerance such as, for example, manufacturing tolerances, measurement tolerances or the like.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors”.

Several nonlimiting examples of connectors include, but are not limited to, thread-to-connect, twist-to-connect, and push-to-connect type devices, opposing strips of hook and loop material (e.g., Velcro®), attractively oriented magnetic elements or magnetic and metallic elements, buckles, clamps, clips, and compression fittings, for example.

The term “permanently secured” shall be used to describe a situation wherein two or more objects are joined together in a manner so as to prevent the same objects from being separated. Several nonlimiting examples of permanent connectors include welds, various adhesives such as glue or resin, and hardware such as nuts and bolts, for example.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

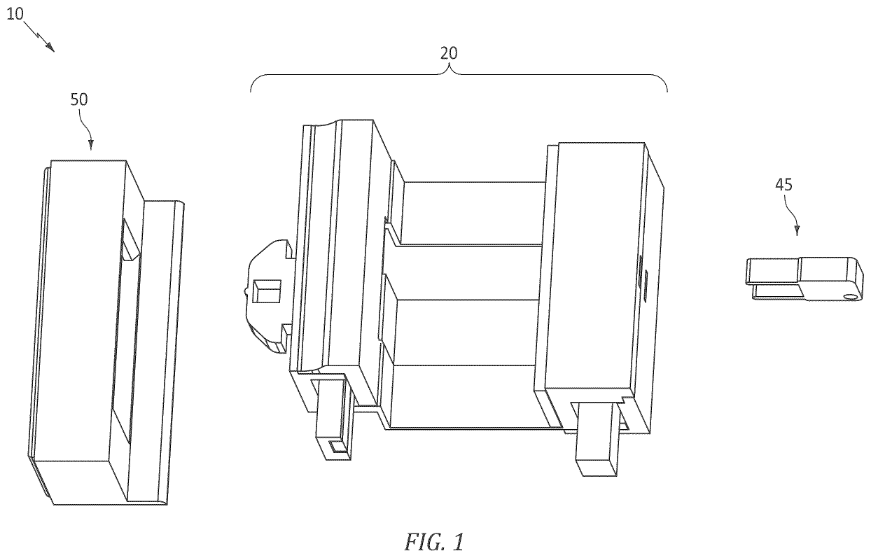

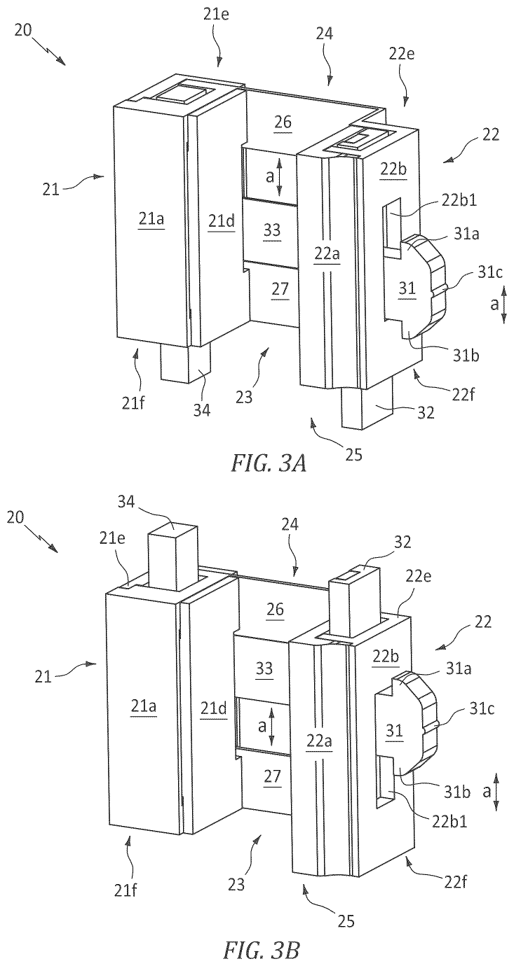

FIGS. 1-7 illustrate one embodiment of a child safety door lock system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “up,” “down,” “top,” “bottom,” “right,” “left,” “front,” “vertical,” “horizontal,” and derivatives thereof shall relate to the invention as oriented in FIG. 3A.

FIG. 1 illustrates one embodiment of a child safety door lock system 10 that includes a door latch device 20 that is designed to be secured onto a door and to selectively engage a door catch device 50 that is mounted on the door frame. The system can also include a retainer key 45 for disabling the operation of the system, and the system components are designed to be installed without damaging the door itself, and to automatically lock so as to prevent the door from being opened by a child or other such individual.

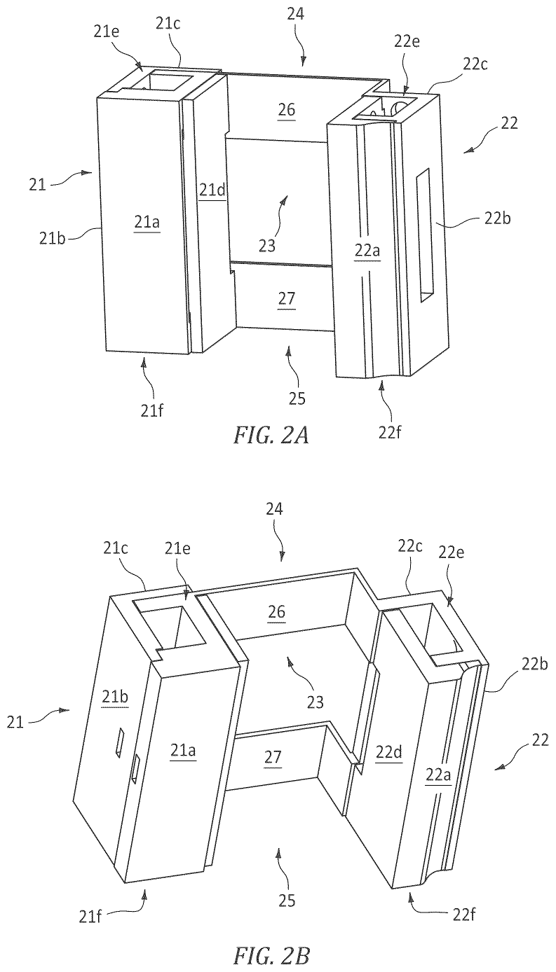

As shown best at FIGS. 2A and 2B, one embodiment of the door latch device can include a main body having a first cavity 21, a second cavity 22, a recessed middle section 23, a top end 24 and a bottom end 25. The first cavity can include a front wall 21a, an outside wall 21b, a back wall 21c an inside facing wall 21d, a top end 21e and a bottom end 21f that define a hollow interior space. The second cavity 22 can also include a front wall 22a, an outside wall 22b, a back wall 22c and inside facing wall 22d, a top end 22e and a bottom end 22f that defines a hollow interior space.

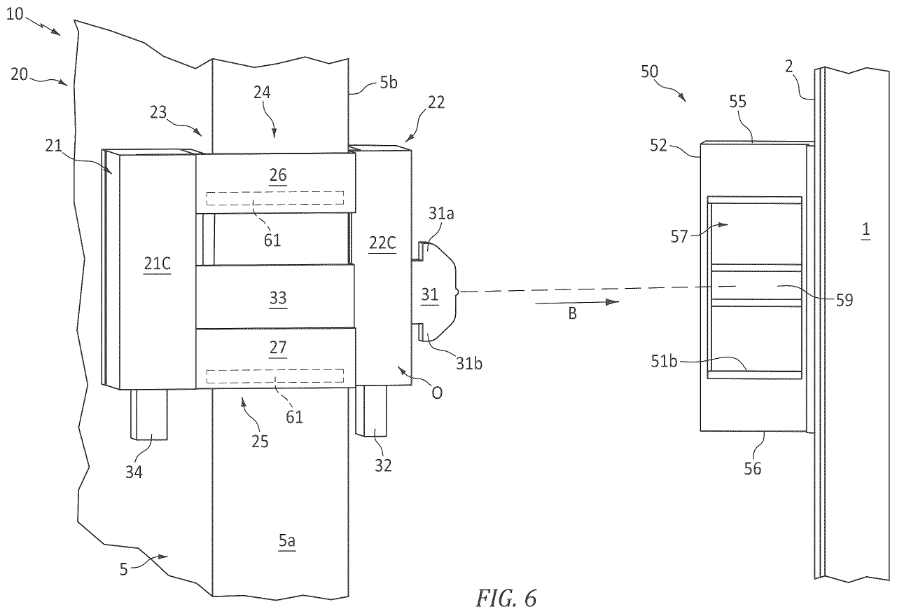

In one embodiment, a pair of generally L-shaped braces 26 and 27 can extend between the inside facing walls 21d and 22d to secure the cavities 21 and 22 together such that cavity 22 is offset/positioned farther away from the braces 26 and 27, relative to the first cavity. Additionally, the middle section 23 can be constructed to include a width (e.g., distance between walls 21d and 22d) that is complementary to the thickness of a door. As described below at FIG. 6, such features are important to allow the device 20 to be positioned onto the edge of a door in a manner that aligns the second cavity with the door latch device.

As described herein, the main body of the door latch device may be formed from materials that are, for example, relatively strong and stiff for their weight. Several nonlimiting examples include but are not limited to various metals or metal alloys, various /astics/ polymers and/or various composite materials.

In various embodiments, the shape and dimensions of the device body allow it to be secured onto the edge of a door utilizing connectors and/or friction so that the device will not slip or otherwise move. To this end, embodiments are contemplated wherein the device can include any number of spacers that can be permanently or removably secured onto the inside facing walls 21d and 22d and/or along the fixed braces 26 and 27 to allow a user to customize the dimensions of the recessed area 23 to ensure the device can be securely positioned onto the edge of any sized door.

As shown best at FIGS. 3A and 3B, one embodiment of the door latch device 20 can include a latch assembly that is positioned within the main body of the device. The latch assembly can include a double-edged hook 31 having a top edge 31a, a bottom edge 31b and a centrally located magnet 31c. The hook 31 can be positioned so as to extend outward through an opening 22b1 on the outside facing wall 22b of the second cavity 22.

The hook is connected to a second post 32 located within the second cavity 22 and a first post 34 located within the first cavity 21. The posts are connected together by a latch arm 33 that extends through slits in the sides of the cavities 21 and 22, such that all components 31-34 move up and down together.

As shown by arrow a, the hook and posts are able to slide between the top and bottom ends of the main body so as to transition the door latch device 20 between a first (resting) position shown at FIG. 3A, and a second position shown at FIG. 3B. In both positions, a portion of each post will extend through the (top or bottom ends of) cavities to allow a user to manually move the hook between the first and second position. This arrangement of components and functionality is important, as it allows the system 10 to be used with both inswing doors and outswing doors by simply rotating the door latch device 180 degrees and mounting the same onto the door.

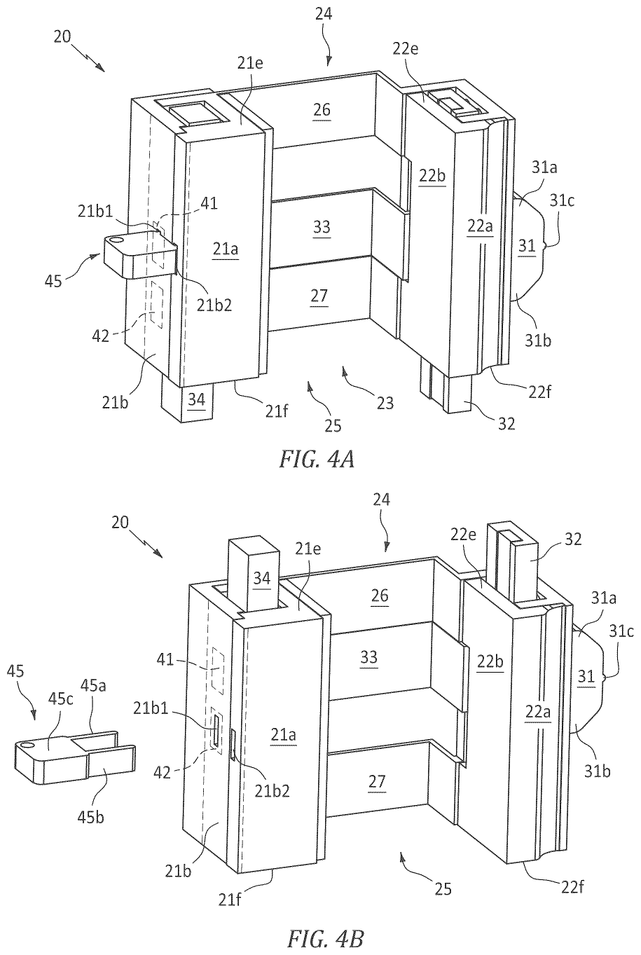

As shown at FIGS. 4A and 4B, one embodiment of the door latch device 20 can include a pair of horizontally aligned key openings 21b1 and 21b2 that are positioned along the outside wall 21b of the first cavity 21, and a pair of vertically aligned notches 41 and 42 that are positioned along the first post 34. As shown, the notches 41 and 42 can be selectively aligned with the key opening 21b1 when the device transitions between the first and second positions.

In one embodiment, the device also includes a retainer key 45 having a pair of protrusions 45a and 45b that extend outward from a grip portion 45c. The protrusions 45a and 45b can be positioned through the openings 21b1 and 21b2 in order to selectively engage one of the notches 41 or 42 to lock the device in either the first position or the second position. Such a feature is important as it allows a user to disable the ability of the device 20 to automatically engage the catch 50 and to allow the door to operate normally without having to uninstall the system components from the door. Such a feature being particularly advantageous for use when no children are present and the use of the device is not desired.

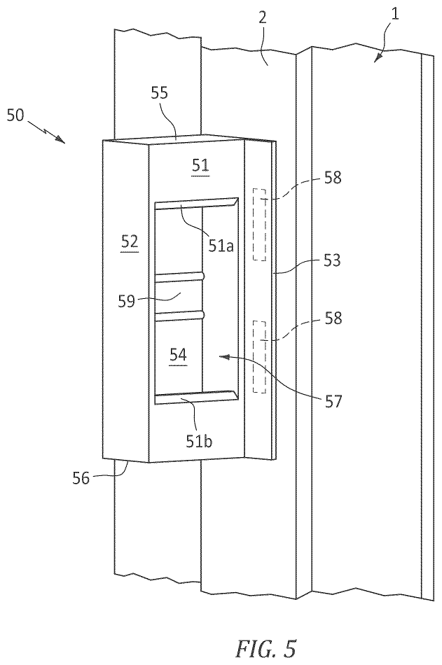

FIG. 5 illustrates one embodiment of a door catch device 50 that includes a generally rectangular-shaped body having a front wall 51 an outside facing sidewall 52, an elongated inside facing sidewall 53, a back wall 54, a top end 55 and a bottom end 56 that define a hollow interior space. In one embodiment, an opening 57 is positioned along the front wall having an upper lip 57a and a lower lip 57b, and a magnet 59 is positioned centrally within the opening along the back wall 54.

The door catch device 50 is designed such that the outside facing sidewall 52 is secured onto the protruding portion/door jamb 2 of a door frame 1 via connectors 58 such as hook and loop material, screws or other such hardware, for example. When so positioned, the opening 57 will be oriented toward the door and will be positioned to receive and engage the hook of the door latch device secured onto the door.

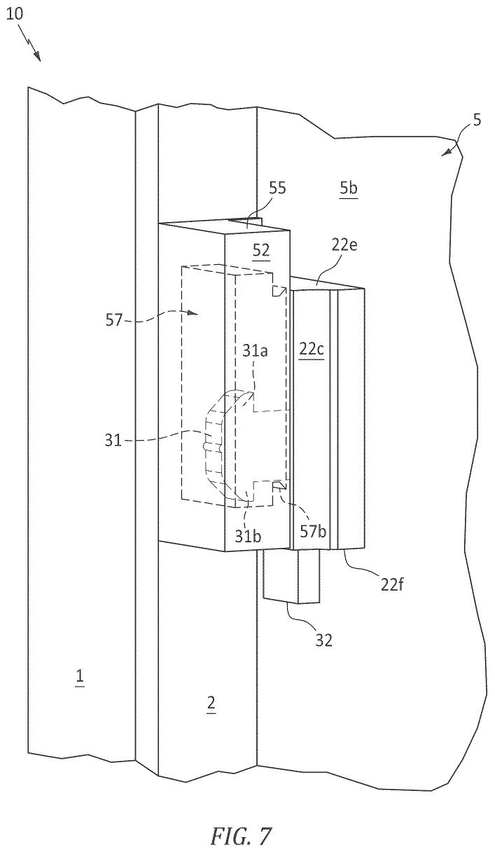

FIGS. 6 and 7 illustrate one embodiment of the system in operation. As shown, the door latch device 20 can be mounted onto the edge 5a of a door 5 such that the edge is sandwiched within the middle portion 23 of the device and the hook 31 is extending outward from the face 5b of the door toward the door frame 1. In the preferred embodiment, connectors 61 such as double-sided tape, or hook and loop material, for example, are provided to secure the device 20 onto the door 5.

When so positioned, the braces 26 and 27 will be firmly against the edge 5a of the door so as to allow the door to open and close against the frame without the braces making contact with the door frame. As shown by arrow O, the second cavity 22 is positioned offset relative to both the first cavity 21 and the braces 26/27. In the preferred embodiment, the offset distance will be about 0.25 inches, which is complementary to the amount the door jamb 2 protrudes from the door frame 1. Such a feature is important in order to align the hook 31 with the opening 57 on the catch device 50 when closing the door (arrow B). Of course, other offset amounts are contemplated for allowing the system to work with doors and door frames having larger or smaller protruding sections.

In either instance, when installed onto the door, gravity will cause the latching mechanism (e.g., components 31-34) to slide to the bottom end 25 of the door latch main body 20, which is the default resting position of the device when installed on inswing doors.

The devices 20 and 50 are horizontally aligned such that as the door swings closed, the angled bottom end 31b of the hook 31 will make contact with the lower lip 57b of the door catch 50. This contact and the continued movement will cause the hook to rise until it passes the threshold of the lip and returns to the first position at which time the hook will be located entirely within the opening 57. When so positioned, the inside facing wall on the rear of the hook will be positioned adjacent to the inside facing wall of the lip within the opening, thus preventing the components from separating and preventing the door from being opened.

This arrangement allows the hook of the door latch device to automatically engage the door catch device when the door is closed without user intervention, thus functioning to automatically lock the door.

When it is desirable to unlock the system and open the door, a user can simply lift either of the posts 32 or 34 which are accessible on both sides of the door. Upon lifting the posts, the device transitions to the second position, and disengages the hook from the lip, thus allowing the components 20 and 50 to be separated and the door to be opened.

Moreover, when the user transitions the device to the second position the hook magnet 31c will be aligned with the catch magnet 58. This alignment engages the magnetic attraction between the components to maintain the door latch device 20 in the second position. Such a feature is advantageous as it allows the user to remove their hand from the device and operate the door handle, thus enabling one handed use of the system when opening a door. Stated differently, without the magnets, a user would have to keep one hand on one of the posts to keep the device in the second position while using their other hand to operate the door handle. In either instance, once the door has been opened and the magnets have been separated, the magnetic attraction will be lost and the door latch device 20 will automatically return to the first position so as to be ready to automatically engage the door catch 50 when the door is next closed.

Although illustrated with regard to an inswing door 5, the system 10 can be used with outswing doors by simply rotating the door latch device by 180 degrees and mounting the device such that the bottom end 25 is positioned above the top end 24 with the hook facing the door catch in the direction the door closes. When so positioned, the device will be oriented in the second position and the hook portion 31a will engage lip 57a when the door is closed.

As to a further description of the manner and use of the present invention, the same should be apparent from the above description. Accordingly, no further discussion relating to the manner of usage and operation will be provided.

As described herein, one or more elements of the above noted device and system can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state “means” for performing a specified function or “step” for performing a specified function should not be interpreted as a “means” or “step” clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A child safety system, comprising:
a door latch body that includes a first end, a second end, a middle section, a top end, and a bottom end;
a latch assembly that is positioned within the door latch body, said latch assembly including a hook that extends outward from the second end;
a catch body having a front wall, and an inside facing sidewall; and
an opening that is disposed in the front wall, said opening having an upper lip and a lower lip,
wherein the door latch body is configured to be secured onto an edge of a door,
wherein the catch body is configured to be secured onto a frame of the door, and
wherein the hook is configured to selectively engage the catch body to secure the door in a locked position when the door is closed against the door jamb.

2. The system of claim 1, wherein the middle section of the door latch body includes a recessed area having a dimension that is complementary to a cross sectional dimension of the door edge.

3. The system of claim 1, wherein the hook is slidingly connected to the door latch body.

4. The system of claim 3, wherein the hook is configured to slidingly engage the upper lip or the lower lip of the catch body to automatically secure the door in the locked position.

5. The system of claim 1, further comprising:
a first cavity that is positioned along the first end of the door latch body.

6. The system of claim 5, further comprising:
a second cavity that is positioned along the second end of the door latch body.

7. The system of claim 6, further comprising:
a first post that is positioned within the first cavity.

8. The system of claim 7, further comprising:
a second post that is positioned within the second cavity.

9. The system of claim 8, further comprising:
a latch arm that is connected to each of the first post and the second post.

10. The system of claim 9, wherein the hook is connected to the second post.

11. The system of claim 9, further comprising:
an opening that is positioned along the second end of the catch body,
wherein the hook extends through the opening.
